(19) United States
(12) Patent Application Publication
(10) Pub. No.: US 2007/0029814 A1
(43) Pub. Date: Feb. 8, 2007

(54) Power release mechanism

(76) Inventors: Peter J. Coleman, Worcestershire (GB); Nigel V. Spurr, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 11/491,537

(22) Filed: Jul. 21, 2006

(30) Foreign Application Priority Data
Jul. 21, 2005 (EP) EP 05254552.2

(51) Int. Cl. E05C 3/06

(52) U.S. Cl. 292/201

(57) ABSTRACT

A power release mechanism for a vehicle door latch includes a rotary claw having a mouth to releasably retain a striker, a pawl abutment and a cam surface. The power release mechanism includes a pivotably mounted pawl resiliently biased to contact the pawl abutment to retain the claw in a latched condition and to contact the cam surface when in a released condition. A power drive formation includes an input member configured to receive drive from a power actuator and an output member. One of the input member and the output member includes first and second stall abutments, and the other of the input member and the output member includes a follower configured for contact with the first and second stall abutments during power release of the pawl. Each of the first and second stall abutments is configured to retain the follower and thereby stall the power actuator. The first stall abutment is contactable by the follower to lift the pawl from the claw. The second stall abutment is contactable by virtue of the cam surface of the claw pivoting the output member away from the input member such that the follower disengages the first stall abutment, resulting in the retention of the follower at the second stall abutment until the pawl relatches with the claw.

### REFERENCE TO RELATED APPLICATION

This application claims priority to European Patent Application EP 05254552.2 filed on Jul. 21, 2005.

### BACKGROUND OF THE INVENTION

The present invention relates generally to a power release mechanism. More particularly, the present invention relates to a power release mechanism for a vehicle door latch.

It is known to have vehicle door latches that employ a power actuator to release the latch. In such latches, a vehicle user does not directly provide the energy to release the latch via a mechanical linkage from a door handle. Instead, an actuator, such as an electric motor, provides the energy to release the latch. Power release mechanisms are typically used on higher specification vehicles to improve the convenience for the vehicle user, or where (because of a high seal load on the door) the energy required to manually release the latch is too high for the latch to be released by a vehicle user.

Nevertheless, for safety reasons, power release latches typically have a backup manual release mechanism to enable the latch to be released in the event the power actuation mechanism fails.

It is desirable to avoid back-driving of the power release actuator to reset the mechanism after release has occurred because this requires additional control functionality which increases costs. It is also desirable to avoid the need for additional switches in the mechanism to provide feedback on the position of the power release mechanism during a release cycle, which again increases cost. It is known to use stepper motors as actuators for power release mechanisms because these obviate the need for switches. However, stepper motors are still more expensive than a standard DC electric motor.

The present invention seeks to overcome, or at least mitigate, the problems of the prior art.

### SUMMARY OF THE INVENTION

The present invention provides a power release mechanism for a vehicle door latch including a rotary claw having a mouth to releasably retain a striker, a pawl abutment and a cam surface. The power release mechanism includes a pivotably mounted pawl resiliently biased to contact the pawl abutment to retain the claw in a latched condition and to contact the cam surface when in a released condition. The power release mechanism also includes a power drive formation having an input member configured to receive drive from a power actuator and an output member. One of the input member and the output member includes first and second stall abutments, and the other of the input member and the output member includes a follower configured for contact with the first and second stall abutments during power release of the pawl. Each of the first and second stall abutments is configured to retain the follower and thereby stall the power actuator.

The first stall abutment is contactable by the follower to lift the pawl from the claw. The second stall abutment is contactable by the follower by virtue of the cam surface of the claw pivoting the output member away from the input member such that the follower disengages the first stall abutment, resulting in the retention of the follower at the second stall abutment until the pawl relatches with the claw.

Another aspect of the present invention provides a method of operating a power release mechanism of the type described in the preceding paragraph. The method includes the step of powering the input member until the mechanism stalls with the follower contacting the second stall abutment.

### BRIEF DESCRIPTION OF THE DRAWINGS

Embodiments of the present invention will now be described, by way of example only, with reference to the accompanying drawings in which:

FIG. 1 is a perspective view of a door latch incorporating a power release mechanism of the present invention in situ on a door;

FIG. 2 is a perspective view of a pawl of the power release mechanism of the present invention;

FIG. 3 is an underside view of a power release lever of the power release mechanism of the present invention;

FIG. 4 is an underside perspective view of the power release lever of the power release mechanism of the present invention;

FIG. 5 is a diagrammatic representation of the latch of FIG. 1;

FIG. 6A is a plan view of the power release mechanism at a stage of the power release operation;

FIG. 6B is a plan view of the power release mechanism at a successive stage of the power release operation;

FIG. 6C is a plan view of the power release mechanism at a successive stage of the power release operation; and

FIG. 6D is a plan view of the power release mechanism at a successive stage of the power release operation.

### DETAILED DESCRIPTION OF THE PREFERRED EMBODIMENT

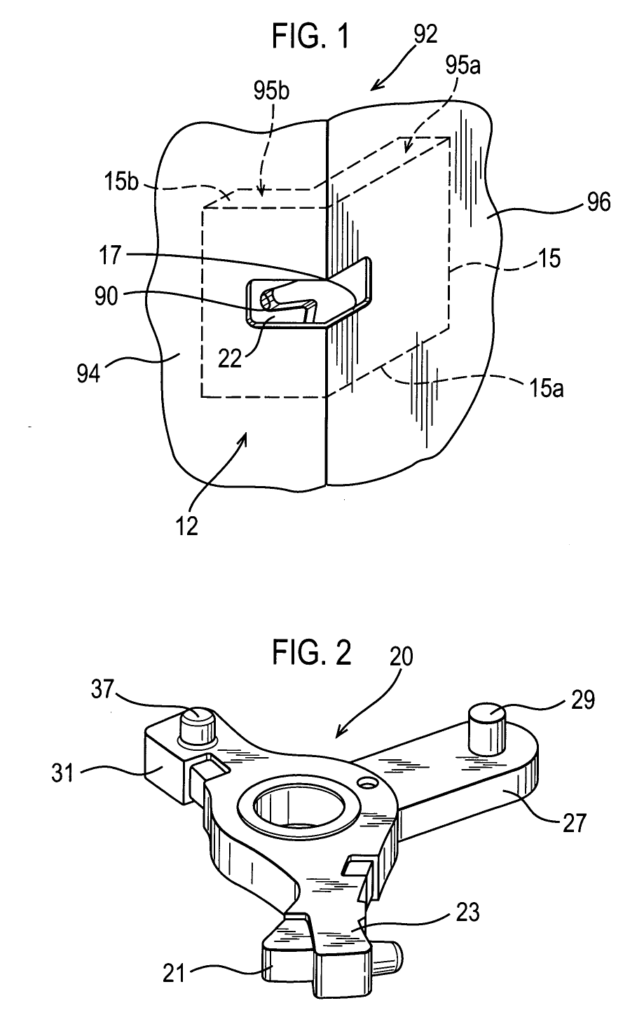

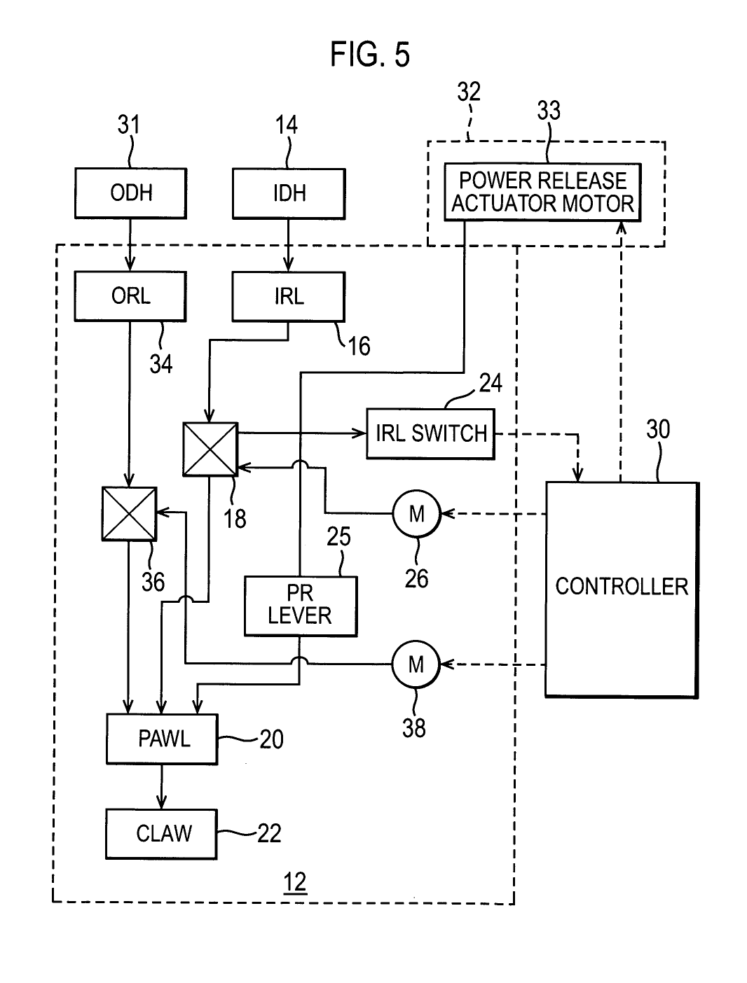

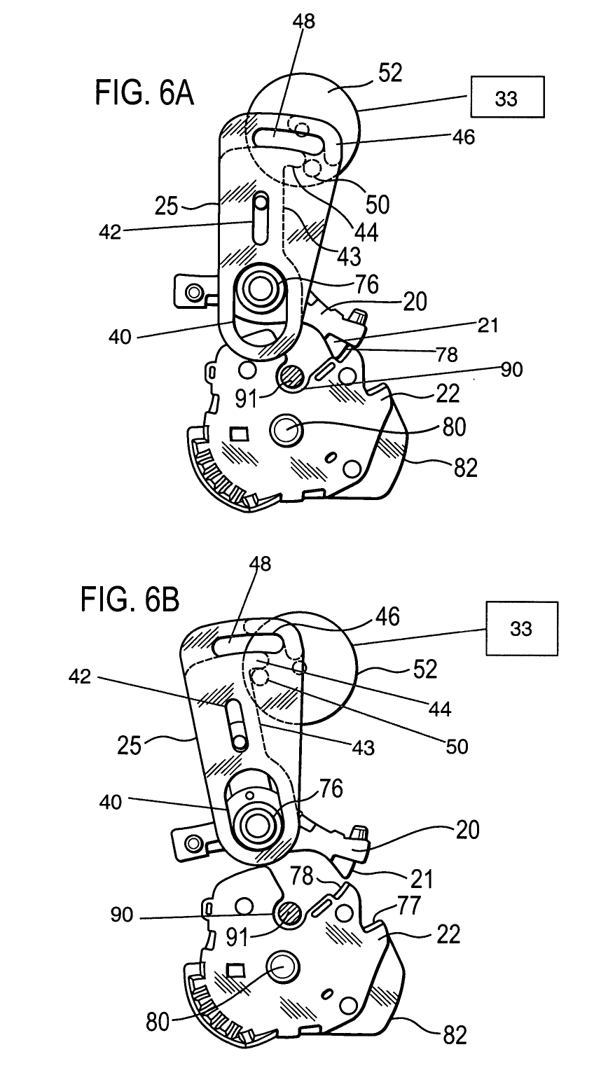

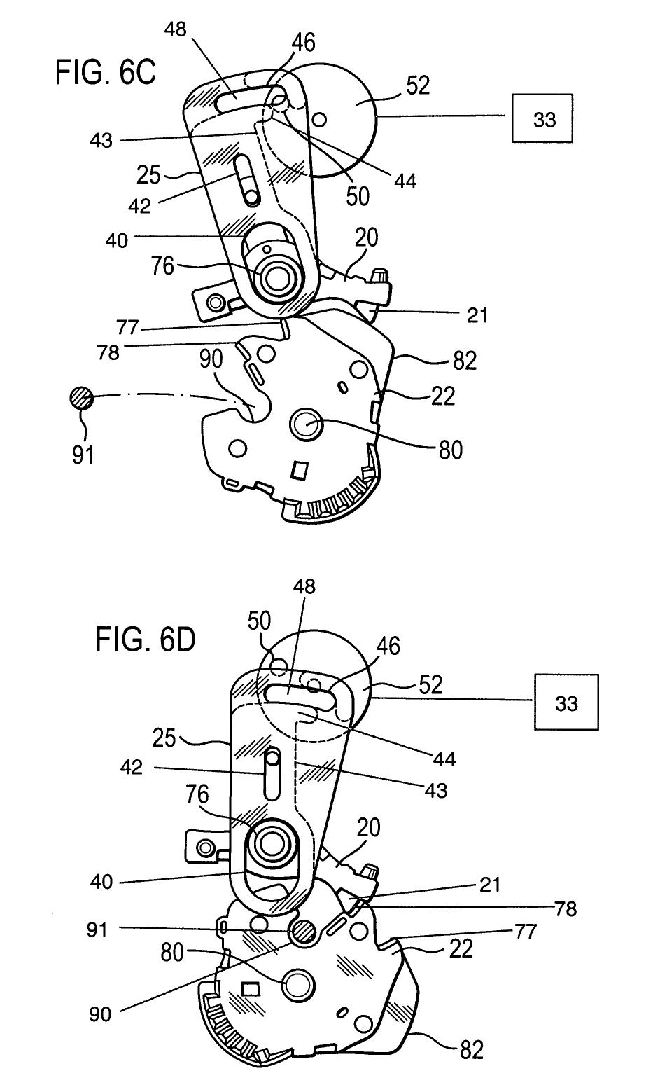

FIGS. 1 and 5 illustrate a latch 12 for a vehicle closure, in this instance a vehicle side passenger door, including a retention plate 15 having an opening 17 (shown in FIG. 1) therein to receive a striker 91 (shown in FIGS. 6A-6D). In FIG. 5, mechanical interconnections are illustrated by arrows with unbroken lines, and electrical connections are illustrated by arrows with broken lines.

As shown in FIG. 1, the retention plate 15 includes two portions: a shut face portion 15b that is arranged to be substantially parallel to a shut face 94 (the face on a trailing edge of a conventional passenger side door) of a door 92 to which the latch 12 is to be fitted and an inside face portion 15a arranged substantially 90 degrees to the shut face portion 15b and substantially parallel to an inner face 96 of the door 92 to which the latch 12 is to be fitted. The opening 17 spans the intersection of the portions 15a and 15b. The inside face portion 15a and the shut face portion 15b of the retention plate 15 provide support for components mounted in an inside face portion or region of the latch 95a and a shut face portion or region of the latch 95b, either directly or indirectly.

FIGS. 1 and 6A to 6D show a latch bolt in the form of a rotatable claw 22 that is pivotally mounted on a pivot 80. The claw 22 is resiliently biased into an open position (i.e., counter-clockwise in FIGS. 6A-6D) by a spring (not shown). The claw 22 includes a mouth 90 arranged to receive a cooperating striker 91 mounted on a door surround in use. The mouth 90, in conjunction with the opening 17 in the retention plate 15, acts to releasably retain the striker 91 when the claw 22 is held by engagement of a pawl 20 with either of a first safety abutment 77 or a fully latched abutment 78 on a periphery of the claw 22. The claw 22 further includes a cam surface 82 at a greater radial distance from the pivot 80 than the outermost edges of the first safety abutment 77 and the fully latched abutment 78.

The pawl 20 is rotatably mounted about a pivot pin 76, which is also secured to the shut face portion 15b. The pawl 20 is resiliently biased into contact with the claw 22 by a spring (not shown).

FIG. 2 shows that the pawl 20 includes three arms 23, 27 and 31. The first arm 23 includes a pawl tooth 21 for engagement with the claw 22. The second arm 27 includes a drive pin 29 for engagement with a power release lever 25 (discussed in more detail below), and the third arm 31 includes a pin 37 for engagement with a back-up manual release mechanism that is not the subject of the present application and thus only briefly discussed.

As shown in FIG. 5, a manual release mechanism of the latch 12 includes an outside release lever (ORL) 34 connected to an outside door handle (ODH) 31 and an inside release lever (IRL) 16 connected to an inside door handle (IDH) 14. Transmission paths 18 and 36 from the inside release lever (IRL) 16 and the outside release lever (ORL) 34, respectively, to the pawl 20 are set in a locked state by motors 26 and 38, respectively, in a known manner and in response to signals from a controller 30. The locked state of the transmission paths 18 and 36 may also be set by mechanical inputs (not shown) from a key barrel (not shown) and/or a sill button (not shown). To indicate when a vehicle user pulls on the inside door handle (IDH) 14, an inside release lever (IRL) switch 24 signals the controller 30. A similar arrangement (not shown) is provided for the outside door handle (ODH) 31.

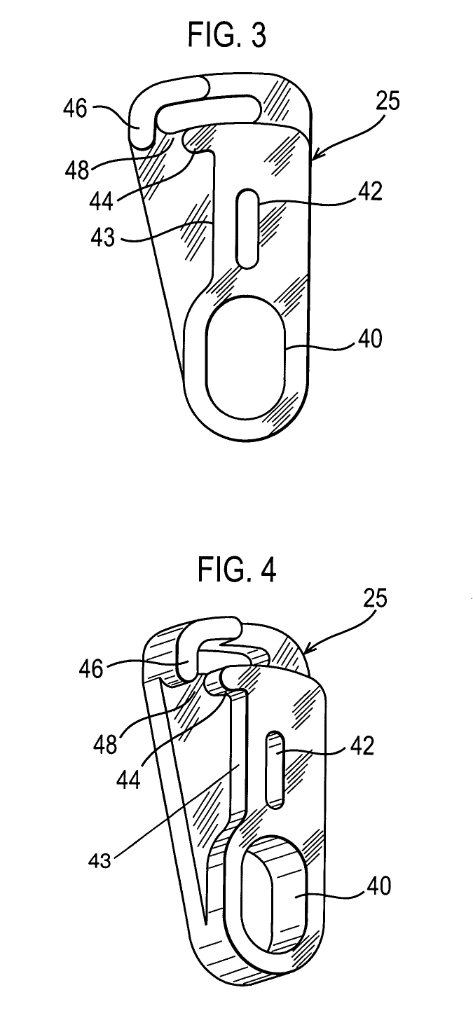

As shown in FIGS. 3 and 4, a power release lever 25 includes a pivot slot 40 to fit over the pawl pivot pin 76. The power release lever 25 further includes a drive slot 42 having a longitudinal axis that is substantially parallel to a longitudinal axis of the pivot slot 40 and which is dimensioned to receive the drive pin 29. The power release lever 25 is biased radially inwards with respect to the pawl 20 by a spring (not shown). As a result, the power release lever 25 rotates in a fixed relationship together with pawl 20, but may move radially relative to the pawl 20 limited by the length of the pivot slot 40 and the drive slot 42.

The power release lever 25 further includes a radially extending release cam surface 43 terminating in a first stall abutment in the form of a first hook 44. The first hook 44 extends in a generally clockwise direction when viewed in FIGS. 6A to 6D.

A second stall abutment in the form of a ‘L’ shaped second hook 46 is provided radially outwards from the first hook 44, and a pathway 48 in the form of a recess exists between the first hook 44 and the second hook 46 through which a follower in the form of an actuator pin 50 may pass.

FIGS. 6A to 6D show the actuator pin 50 eccentrically mounted on a gear wheel 52 driven by a power release actuator motor 33 e.g., a standard DC electric motor (see FIG. 5) via a reduction gear (not shown).

The release operation is now discussed in relation to FIGS. 6A to 6D. In FIG. 6A, a vehicle user has signalled release of the latch 12, either by pulling on the inside door handle (IDH) 14 or the outside door handle (ODH) 31 or by the use of a remote keyless entry device (not shown) in wireless communication with the controller 30. The controller 30 has determined in accordance with its internal logic that power release is to be permitted and has signalled the power release actuator motor 33 accordingly. As a result, the actuator pin 50 has rotated to a position ready to initiate the latch release procedure. However, the latch 12 remains fully latched.

In FIG. 6B, the actuator pin 50 has turned clockwise approximately 90°, causing the actuator pin 50 to contact the release cam surface 43 of the power release lever 25. This causes the power release lever 25, and hence the pawl 20, to rotate counter-clockwise and the pawl tooth 21 to lift clear of the fully latched abutment 78 of the claw 22. The actuator pin 50 has translated the power release lever 25 radially outwards with respect to the pawl 20, and the actuator pin 50 is retained by the first hook 44. This prevents further rotation of the gear wheel 52, causing the power release actuator motor 33 to stall temporarily.

Because the claw 22 is now no longer retained by the pawl 20, the claw 22 rotates counter-clockwise as shown in FIG. 6C, thereby releasing the striker 91. This counter-clockwise rotation of the claw 22 causes the pawl tooth 21 to contact the cam surface 82. Because the distance from the cam surface 82 to the center of rotation of the claw 22 is greater than the distance from the outer front edge of the fully latched abutment 78, the pawl 20 (together with the power release lever 25) pivots further in a counter-clockwise direction, thus releasing the actuator pin 50 from the first hook 44.

As a result, the actuator pin 50 is free to rotate further and enters the passageway 48 between the first hook 44 and the second hook 46. By virtue of the arcuate path of the actuator pin 50, the actuator pin 50 is now retained by the second hook 46 and therefore causes the power release actuator motor 33 to stall for the second occasion. In a preferred embodiment, the controller 30 signals the power release actuator motor 33 to power for a predetermined time (e.g., 0.4 s) before power is stopped. This gives sufficient time for the power release actuator motor 33 to drive the actuator pin 50 from a rest position past the first hook 44 and to stall on the second hook 46 with the latch 12 fully released, but not long enough to damage the power release actuator motor 33. In other embodiments, the stalled state of the power release actuator motor 33 is detected by the controller 30 due to the increasing current passing through the power release actuator motor 33 or due to a door open switch that is triggered by the cam surface 82 of the claw 22. In all of the above embodiments, the internal logic of the controller 30 cuts power to the power release actuator motor 33 with the actuator pin 50 in a known position on its arcuate path.

With reference to FIG. 6D, when a vehicle user shuts a door, the striker 91 re-enters the mouth 90 of the claw 22, and the claw 22 rotates clockwise until the limit of its travel is reached. By biasing the pawl 20 into contact with the periphery of the claw 22, the pawl tooth 21 self-engages against the fully latched abutment 78 of the claw 22. The resultant clockwise rotation of the pawl 20 and the power release lever 25 releases the actuator pin 50 from the second hook 46 without requiring any movement of the actuator pin 50. As a result, the actuator pin 50 remains in a known position.

To repeat the release process, the controller 30 merely needs to power the power release actuator motor 33 for a predetermined period of time which is sufficient such that the actuator pin 50 rests against the second hook 46 when the supply of power to the power release actuator motor 33 is stopped.

It is therefore apparent that a reliable release procedure of the claw 22 can be achieved without requiring back-driving of the power release actuator motor 33, the use of springs to reverse the actuator motor drive, switches to detect the position of the mechanism at any point during the release procedure, or potentially the sensing of the stalling of the power release actuator motor 33.

The term “power release actuator” should be understood to encompass any actuator driven by a vehicle power source, such as a vehicle battery. Specifically, the term should not be understood to mean an actuator, such as a door handle, whose power source is a vehicle user. Terms such as “clockwise” and “counter-clockwise” should not be construed as limiting and are merely used for explanation purposes.

It will be understood that numerous changes may be made within the scope of the present invention. The actuator pin 50 could be resiliently biased in a clockwise direction with respect to the gear wheel 52, and as a result the power release lever 25 could be integral with the pawl 20. The hooks 44 and 46 could be provided on the gear wheel 52 and the actuator pin 50 on the power release lever 25. The latch 12 may omit the mechanical back-up functions described in relation to FIG. 5. The particular shape of hooks 44 and 46 may be adjusted as is required dependent upon the geometry of the various components making up the release system.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A power release mechanism for a vehicle door latch, the power release mechanism comprising:
a rotary claw including a mouth to releasably retain a striker, the rotary claw further including a pawl abutment and a cam surface;
a pivotably mounted pawl resiliently biased to contact the pawl abutment of the rotary claw and retain the rotary claw in a latched condition, and to contact the cam surface of the rotary claw when in a released condition; and
a power drive formation including an input member and an output member, wherein the input member is configured to receive drive from a power actuator,
wherein one of the input member and the output member includes a first stall abutment and a second stall abutment and the other of the input member and the output member includes a follower configured for contact with the first stall abutment and the second stall abutment during power release of the pivotably mounted pawl,
wherein each of the first stall abutment and the second stall abutment is configured to retain the follower and thereby stall the power actuator,
wherein the first stall abutment is contactable by the follower to lift the pivotably mounted pawl from the rotary claw, and
wherein the second stall abutment is contactable by the follower by virtue of the cam surface of the rotary claw pivoting the output member away from the input member such that the follower disengages the first stall abutment, resulting in the retention of the follower at the second stall abutment until the pivotably mounted pawl relatches with the rotary claw.

2. The power release mechanism according to claim 1 wherein the output member of the power drive formation includes a power release lever.

3. The power release mechanism according to claim 2 wherein the power release lever is integral with the pivotably mounted pawl.

4. The power release mechanism according to claim 2 wherein the power release lever is mounted for rotation together with the pivotably mounted pawl.

5. The power release mechanism according to claim 4 wherein the power release lever is mounted for limited movement radially with respect to the pivotably mounted pawl.

6. The power release mechanism according to claim 5 wherein the power release lever is biased radially inwardly with respect to the pivotably mounted pawl.

7. The power release mechanism according to claim 2 wherein the power release lever includes the first stall abutment and the second stall abutment.

8. The power release mechanism according to claim 1 wherein the input member of the power drive formation is driveable on an arcuate path.

9. The power release mechanism according to claim 1 wherein the follower is a pin.

10. The power release mechanism according to claim 9 further including an input gear wheel, wherein the pin is mounted on the input gear wheel for motion in a circular path.

11. The power release mechanism according to claim 1 wherein the input member is resiliently mounted with respect to the power actuator.

12. The power release mechanism according to claim 1 wherein a pathway for the input member is defined between the first stall abutment and the second stall abutment.

13. The power release mechanism according to claim 1 wherein the rotary claw includes a center of rotation, and the cam surface of the rotary claw has a radial distance from the center of rotation of the rotary claw that is greater than a radially outmost edge of the pawl abutment of the rotary claw.

14. A vehicle door latch comprising:
a power release mechanism including:
a rotary claw including a mouth to releasably retain a striker, the rotary claw furthering including a pawl abutment and a cam surface;
a pivotably mounted pawl resiliently biased to contact the pawl abutment of the rotary claw and retain the rotary claw in a latched condition, and to contact the cam surface of the rotary claw when in a released condition; and
a power drive formation including an input member and an output member, wherein the input member is configured to receive drive from a power actuator,
wherein one of the input member and the output member includes a first stall abutment and a second stall abutment and the other of the input member and the output member includes a follower configured for contact with the first stall abutment and the second stall abutment during power release of the pivotably mounted pawl,
wherein each of the first stall abutment and the second stall abutment is configured to retain the follower and thereby stall the power actuator,
wherein the first stall abutment is contactable by the follower to lift the pivotably mounted pawl from the rotary claw, and
wherein the second stall abutment is contactable by the follower by virtue of the cam surface of the rotary claw pivoting the output member away from the input member such that the follower disengages the first stall abutment, resulting in the retention of the follower at the second stall abutment until the pivotably mounted pawl relatches with the rotary claw.

15. A method of operating a power release mechanism for a vehicle door latch, the power release mechanism including:
a rotary claw including a mouth to releasably retain a striker, the rotary claw further including a pawl abutment and a cam surface,
a pivotably mounted pawl resiliently biased to contact the pawl abutment of the rotary claw and retain the rotary claw in a latched condition, and to contact the cam surface of the rotary claw when in a released condition, and
a power drive formation including an input member and an output member, wherein the input member is configured to receive drive from a power actuator,
wherein one of the input member and the output member includes a first stall abutment and a second stall abutment and the other of the input member and the output member includes a follower configured for contact with the first stall abutment and the second stall abutment during power release of the pivotably mounted pawl,
wherein each of the first stall abutment and the second stall abutment is configured to retain the follower and thereby stall the power actuator,
wherein the first stall abutment is contactable by the follower to lift the pivotably mounted pawl from the rotary claw, and
wherein the second stall abutment is contactable by the follower by virtue of the cam surface of the rotary claw pivoting the output member away from the input member such that the follower disengages the first stall abutment, resulting in the retention of the follower at the second stall abutment until the pivotably mounted pawl relatches with the rotary claw,
the method comprising the step of:
powering the input member with the follower contacting the second stall abutment until the power release mechanism stalls.
